(19) United States
(12) Patent Application Publication
(10) Pub. No.: US 2011/0262654 A1
(43) Pub. Date: Oct. 27, 2011

(54) PROCESS FOR PREPARING POLYMER PARTICLES CONTAINING METALLIC FLAKES

(76) Inventors: Mathew Z. Yates, Fairport, NY (US); Weisi Yin, Appleton, WI (US); Xiqiang Yang, Webster, NY (US); Mridula Nair, Penfield, NY (US)

(21) Appl. No.: 12/766,944

(22) Filed: Apr. 26, 2010

(51) Int. Cl. B05D 3/14; B05D 3/12

(52) U.S. Cl. 427/532; 427/222

(57) ABSTRACT

A process for forming polymer particles containing metallic flakes, comprising: a) forming a suspension of metallic flakes in a solution of a polymeric binder in a solvent; b) forming droplets of the suspension, c) freezing the droplets to freeze solvent in the droplets to form frozen solvent domains within the polymeric binder, and d) removing the frozen solvent from the polymeric binder thereby forming porous polymer particles containing the metallic flakes encapsulated therein.

### FIELD OF THE INVENTION

This invention relates to a process for preparing polymer particles with encapsulated metallic flakes, more particularly to a process of preparing porous polymer particles containing metallic flakes using a spray/freeze drying technique. Such polymer particles containing embedded metallic flakes can be useful in printing for producing a metallic hue.

### BACKGROUND OF THE INVENTION

Printing processes serve not only to reproduce and transmit objective information, but also to convey esthetic impressions, such as with coffee-table books and in pictorial advertising. An immense problem here is posed in particular by the reproduction of metallic hues. Metallic hues are only imperfectly reproducible by a color mixture formed from primary colors, especially the colors cyan, magenta, yellow, and black (CMYK). A gold tone is particularly difficult to reproduce by means of such a color mixture. It has therefore been proposed to incorporate metallic pigments or particles in the printing ink in order that a metallic color may be brought about directly. This in practice has been used in many commercial liquid printing inks. But with dry toners, where magnetic and/or electrical and especially electrostatic properties are decisive, this is particularly problematic, since metallic constituents may have an adverse effect on these properties.

Nevertheless, there have already been proposals in the art to form toners with metallic constituents. For instance, U.S. Pat. No. 5,180,650, issued on Jan. 19, 1993, discloses providing a toner composition, which contains lightly colored metallic constituents, such as copper, silver, or gold, for example, in a coating, which in turn has been provided with an over-coating comprised of a metal halide. But the appearance of prints in particular may be adversely affected by chemical reactions of the metallic constituents with the halides, which can cause oxidation of the constituents. For instance, tarnishing with which everyone is familiar from copper or silver objects may occur, making the metallic quality unattractive or disappear completely. Moreover, these toners are only lightly metallically colored, which is insufficient to reproduce a gold tone in printed matter.

More recently, there have been proposals to modify the surface of metallic flakes such that it becomes hydrophobic and non-conductive, in order to be used in electrophotography. U.S. Pat. No. 7,326,507 to Schulze-Hagenest et al. incorporated herein by reference for all that they contain, discloses the preparation of a toner for producing a metallic hue. Metallic pigment particles are coated with a silicate followed by an organic layer, and the resulting particles are combined with toner materials. However, the metallic flakes may not effectively be encapsulated in the toner materials. Thus, there is a possibility that the metallic pigment itself may be detached from the toner polymer binder during the particle making process, which can in turn cause problems during printing such as transfer and cleaning.

### SUMMARY OF THE INVENTION

It is an object of the present invention to provide a process for forming a polymer particle that encapsulates metallic flakes in high efficiency.

It is further an object of the present invention to provide such a process for forming a porous polymer particle containing metallic flakes.

It is still another object of the present invention to directly utilize commercial metallic flakes in such processes so that further surface modifications are not needed.

These and other objects can be achieved according to the present invention, which is directed towards a process for forming polymer particles containing metallic flakes, comprising:

a) forming a suspension of metallic flakes in a solution of a polymeric binder in a solvent;

b) forming droplets of the suspension;

c) freezing the droplets to freeze solvent in the droplets to form frozen solvent domains within the polymeric binder; and

d) removing the frozen solvent from the polymeric binder thereby forming porous polymer particles containing the metallic flakes encapsulated therein.

### BRIEF DESCRIPTION OF THE DRAWINGS

FIG. 1 is a schematic drawing of the electrospray apparatus employed in accordance with an embodiment of the present invention;

FIG. 2 is a schematic drawing of the coaxial spray nozzle employed in accordance with an embodiment of the present invention;

FIG. 3 is an SEM image of porous particles from Example 1;

FIG. 4A is an SEM image of porous particles from Example 3;

FIG. 4B is an SEM image of a sample of Example 3 containing freeze-fractured particles;

FIG. 5 is an SEM image of a cross-section of an individual particle made by spray/freeze drying in accordance with an embodiment of the invention containing A1 flakes cut by microtome; and

FIG. 6 is an SEM image of the inner structure of a porous polyester particle prepared in accordance with an embodiment of the invention which has been freeze-fractured.

For a better understanding of the present invention, together with other advantages and capabilities thereof, reference is made to the following detailed description in connection with the above-described drawings.

### DETAILED DESCRIPTION OF THE INVENTION

The present invention is directed towards a method for the preparation of a porous polymeric particle encapsulating metallic flakes. A polymer material is dissolved in an organic solvent to form an organic phase to which are added metal or metallic flakes to form a suspension. Droplets of the resulting suspension are formed by, e.g., spraying the suspension through a capillary nozzle. The droplets are frozen by spraying into a cold environment where the solvent in the droplets is rapidly frozen to form frozen solvent domains within the polymer, and the resulting cold solid drops are dried, preferably under reduced pressure, so that the solvent is removed and porous polymer particles are collected. The porous particle is composed of a polymer and at least one flake-like metallic material, and has an internal porosity of at least 10 volume %.

In accordance with the present invention, a metallic flake, or platelet, suitable for the spray freeze drying process can be from any of the available commercial sources of metallic flakes in powder or in suspension form. The flakes or platelets are substantially 2-dimensional particles, having opposed main surfaces or faces separated by a relatively minor thickness dimension. The flakes used are preferably primarily in a range of from about 2 to 50 microns in main surface equivalent circular diameter (ECD), where the equivalent circular diameter is the diameter of a circle having the same area as the main face. More preferably, the metallic flakes have a main surface equivalent circular diameter primarily in a range of from about 2 to 20 microns, and even more preferably, in a range of from about 3 to 15 microns. Flake or platelet shaped particles are further characterized in having an aspect ratio (ratio of main face equivalent circular diameter to thickness) of at least 2, and more preferably, of at least about 5. Commercially available metallic flakes typically may have aspect ratios of from 5 to 40, or even higher.

Examples of usable metallic flakes include those from Ciba Specialty Chemicals, a Division of BASF, such as aluminum flakes METASHEEN 91-0410, in ethyl acetate, and those from NanoDynamics such as copper flakes Grade C1-4000F, 4 μm, solid powder. Other metal flakes include but not are limited to tin, gold, silver, platinum, rubidium, brass, bronze, stainless steel, zinc, and mixtures thereof. In addition to pure metal flakes, metal or metal oxide coated materials such as metallic oxide-coated mica, metallic oxide-coated glass, and mixtures thereof can be used as metallic flakes. A gold tone can be achieved with genuine gold; however, copper and zinc, preferably in the form of an alloy, which depending on the composition can thus be referred to as brass or bronze, may alternatively be used. Preferably, the ratio of copper and zinc fractions in the alloy varies from about 90:10 to about 70:30. As the zinc fraction in the alloy increases, the metallically golden hue changes from a more reddish to a more yellowish or even greenish gold tone. The color of the gold tone may be intensified through a controlled oxidation of the metal. A silver tone can result from the metallic flakes containing among other possibilities, aluminum.

The metallic flakes are used in the organic mixture in which the concentration of the metallic flakes ranges from about 3% to 30%, by weight, based upon the total weight of solids. More preferably, the metallic flakes are used in the amount of 4% to 25%, by weight, based on the total weight of solids.

The solvents for use in the present invention may be selected from among any of the well-known solvents capable of dissolving polymers and at the same time preferably having relatively high freezing temperature or melting point. The melting point (mp.) of the solvent is preferably in a range of from −100° C. to 30° C., and more preferably in a range of from −50° C. to 20° C. Typical of the solvents chosen for this purpose are dimethyl carbonate (mp. 2-4° C.), diethyl carbonate (mp. −43° C.), methyl ethyl carbonate (mp. −55° C.), benzene (mp. 5.5° C.), and the like. Dimethyl carbonate is preferred.

Depending upon desired end use of the particles containing encapsulated metallic flakes prepared by the process of the invention, various additives may be incorporated in the solvent. For particles intended to be used as electrophotographic toners, e.g., additives such as charge control agents, waxes and lubricants may be employed. Suitable charge control agents are disclosed, for example, in U.S. Pat. Nos. 3,893,935; 4,079,014; 4,323,634; 4,394,430 and British Patents 1,501,065; and 1,420,839. Additional charge control agents which are useful are described in U.S. Pat. Nos. 4,624,907; 4,814,250; 4,840,864; 4,834,920; 4,683,188 and 4,780,553. Mixtures of charge control agents can also be used. Charge control agents are generally employed in small quantities such as from about 0.1% to 10% by weight based upon the weight of the total solids and preferably from about 0.2% to about 5.0%.

Waxes useful in the present invention include low-molecular weight polyolefins such as polyethylene, polypropylene and polybutene; silicone resins which can be softened by heating; fatty acid amides such as oleamide, erucamide, ricinoleamide, and stearamide; vegetable waxes such as carnauba wax, rice wax, candelilla wax, Japan wax, and jojoba oil; animal waxes such as bees wax; mineral and petroleum waxes such as montan wax, ozocerite, ceresine, paraffin wax, microcrystalline wax, and Fischer-Tropsch wax; and modified products thereof. Irrespective to the origin, waxes having a melting point in a range of from 30 to 150° C. are preferred and those having a melting point in a range of from 40 to 140° C. are more preferred. The wax may be used in the amount of, for example, 1 to 20% by weight, and preferably 2 to 15% by weight, based on the particle.

Wax may be incorporated into the polymer particle through several ways. The wax may be first dispersed in an appropriate polymer binder by melt compounding and then mixed with the solvent to form the organic suspension for spraying. It may also be separately processed into a fine dispersion in an organic solvent, with appropriate dispersing aids. In all cases the wax exists in the final particle as fine solid particles.

Further, compatibilizing materials for metallic flakes may be added in the solution. Such materials can be, e.g., fatty acids, amides, anhydrides, epoxides, or amines. Such materials can be mixed into the organic solvent together with the metallic flakes, or added to the suspension of flakes after it is prepared to help prevent the flocculation or sedimentation of the metallic flakes.

Agents that are surface active may have an impact on the liquid break-up to form droplets. Such agents can be used in the suspension of the metallic flakes/polymer binder mixture to improve the resulting particle size and particle size distribution. The suspension of solvent, polymer, metallic flakes and other addenda is then be sprayed into a cold environment such as a reservoir of liquid nitrogen, where the sprayed droplets undergo rapid phase separation and freezing of the solvent to form frozen domains of the solvent in the polymer binder. Removal of the solvent under freeze drying conditions yields porous polymer particles with encapsulated metallic flakes.

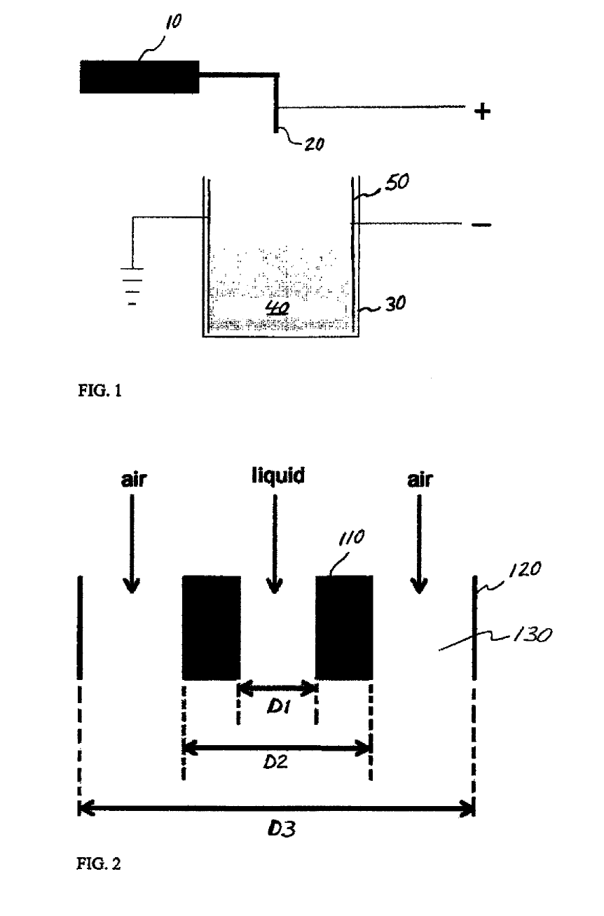

In accordance with the present invention, the organic suspension can be sprayed to form the droplets, e.g., using either an electrospray (FIG. 1) or coaxial nozzle spray (FIG. 2) process. As illustrated in FIG. 1, when electrospray is used, the suspension may be supplied from a reservoir 10 and sprayed through a nozzle 20 into a Dewar flask 30 containing liquid nitrogen 40. An electrical voltage is applied across the nozzle 20 and a receiving plate 50 (e.g., aluminum foil), which is preferably set at above 10,000 volts. As illustrated in FIG. 2, with coaxial nozzle spray, the liquid suspension is supplied through an inner conduit capillary nozzle 110, which is surrounded by an outer sleeve 120 forming an annular region 130, through which air or other gaseous material is flowed. The inner diameter D1 of the capillary nozzle is preferably set at about 50 microns to about 400 microns. More preferably, the nozzle has an inner diameter of from about 100 microns to about 350 microns, and even more preferably from about 100 to about 250 microns. The outer diameter D2 of the capillary nozzle 110 may typically be from about 100 to 1000 microns, and will be determined by D1 and the thickness of the inner conduit wall. The diameter D3 of the outer annular region 120 may typically be, e.g., from about 500 to 1500 microns.

The resulting particle size depends on the droplet size as the liquid suspension is sprayed, and it can be controlled by varying the nozzle diameters, flow rate of the solution through the capillary nozzle, and the air or other gaseous fluid flow through the outer sleeve. To optimize through put and control of particle size, nozzle diameters as described above are used in combination with a polymer solution flow rate through the inner conduit controlled within a range of from about 10 mL/hour to about 40 mL/hour, and preferably from about 15 mL/hour to about 35 mL/hour. Correspondingly, the air flow through the outer sleeve is varied by setting the pressure of the air flow at about 20 psig to about 50 psig, more preferably at about 25 psig to about 45 psig.

As mentioned, the particle size obtained depends on the conditions of the spray process and the composition of the organic suspension. Typically particles are preferably formed in a range of from 1 to 100 microns in diameter, and more preferably, particles in a size range from 5 to 50 microns are desired.

The present invention is applicable to the preparation of polymeric particles from any type of polymer that is capable of being dissolved in a solvent that is frozen when in the cold environment. Useful particle binder polymers include those derived from vinyl monomers, such as styrene and acrylic monomers, and condensation monomers such as esters and mixtures thereof. As the binder polymer, known binder resins are useable. Concretely, these binder resins include homopolymers and copolymers such as polyesters and polymers derived from styrenes, e.g. styrene and chlorostyrene; monoolefins, e.g. ethylene, propylene, butylene, and isoprene; vinyl esters, e.g. vinyl acetate, vinyl propionate, vinyl benzoate, and vinyl butyrate; α-methylene aliphatic monocarboxylic acid esters, e.g. methyl acrylate, ethyl acrylate, butyl acrylate, dodecyl acrylate, octyl acrylate, phenyl acrylate, methyl methacrylate, ethyl methacrylate, butyl methacrylate, and dodecyl methacrylate; vinyl ethers, e.g. vinyl methyl ether, vinyl ethyl ether, and vinyl butyl ether; and vinyl ketones, e.g. vinyl methyl ketone, vinyl hexyl ketone, and vinyl isopropenyl ketone; and mixtures thereof. Particularly desirable binder polymers/resins include polystyrene resin, polyester resin, copolymers derived from styrene and acrylic monomers such as styrene/alkyl acrylate copolymers and styrene/alkyl methacrylate copolymers, styrene/acrylonitrile copolymer, styrene/butadiene copolymer, styrene/maleic anhydride copolymer, polyethylene resin and polypropylene resin. They further include polyurethane resin, epoxy resin, silicone resin, polyamide resin, modified rosin, paraffins, and waxes. Also, especially useful are polyesters of aromatic or aliphatic dicarboxylic acids with one or more aliphatic diols, such as polyesters of isophthalic or terephthalic or fumaric acid with dials such as ethylene glycol, cyclohexane dimethanol and bisphenol adducts of ethylene or propylene oxides. Specific examples are described in U.S. Pat. Nos. 5,120,631; 4,430,408; and 5,714,295, all incorporated herein by reference, and include propoxylated bisphenol-A fumarate, such as FINETONE 382 ES from Reichold Chemicals, formerly ATLAC 382 ES from ICI Americas Inc.

The polymer is used in the organic suspension at a concentration of about 5% to 50% in the organic solvent. More preferably it is used at a concentration from about 10% to about 30%.

Conventional pigments and dyes may be employed in the present invention in combination with such metallic flakes. Pigments suitable for use in the practice of the present invention should be capable of being dispersed in the polymer solution, and preferably yield strong permanent color. Typical of such pigments are the organic pigments such as phthalocyanines, lithols and the like, and inorganic pigments such as TiO₂, carbon black, and the like. Typical of the phthalocyanine pigments are copper phthalocyanine, a mono-chlor copper phthalocyanine, and hexadecachlor copper phthalocyanine. Other organic pigments suitable for use herein include anthraquinone vat pigments such as vat yellow 6GLCL1127, quinone yellow 18-1, indanthrone CL1106, pyranthrone CL1096, brominated pyranthrones such as dibromopyranthrone, vat brilliant orange RK, anthramide brown CL1151, dibenzanthrone green CL1101, flavanthrone yellow CL1118, azo pigments such as toluidine red C169 and hansa yellow; and metalized pigments such as azo yellow and permanent red. The carbon black may be any of the known types such as channel black, furnace black, acetylene black, thermal black, lamp black and aniline black. The pigments may be employed in an amount sufficient to give a content thereof in the particle from about 1% to 40%, by weight, based upon the weight of the particle, and preferably within a range of from 4% to 20%, by weight.

The process of the present invention will now be more particularly described with reference to some examples which might reveal further inventive features, but to which the present invention is not restricted in its scope.

### EXAMPLES

Aluminum flakes were purchased from Ciba Specialty Chemicals (METASHEEN 91-0410) as a slurry dispersed in ethyl acetate, and dried prior to use. Copper flakes were from NanoDynamics (Grade C1-4000F, 4 μm, solid). PICCOTONER 1221, a styrene-acrylic resin, was from Hercules-Sanyo. FINETONE polyester resin was obtained from Kao Corporation. Other chemicals were purchased from Aldrich and used as received.

Particle size analysis. Unless indicated otherwise, the particle diameter was measured manually for each particle in several scanning electronic microscopy (SEM) images. Generally about 1000 particles were counted. The number average diameter

$${D}_{n} = {\sum }_{i = 1}^{N} {D}_{i} / N ,$$

weight average diameter

$${D}_{w} = {\sum }_{i = 1}^{N} {D}_{i}^{2} / {\sum }_{i = 1}^{N} {D}_{i} ,$$

and polydispersity index PDI=D_{w}/Dₙ were calculated.

### Example 1

### Electrospray Freeze Drying Method for Preparation of Porous Particles

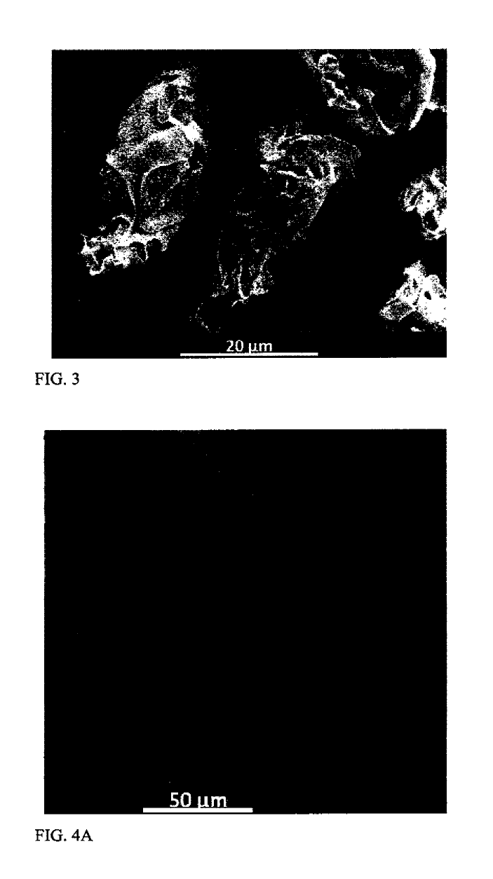

Polymer (PICCOTONER 1221, 12% w/v) solution containing METASHEEN aluminum flakes (8% w/w based on PICCOTONER 1221) with dimethyl carbonate (DMC) as the solvent was pumped through an 18 gauge stainless steel needle at 0.4 mL/hr in an electrospray apparatus as schematically shown in FIG. 1 as described above. An electric field of 15 kV was applied to the needle relative to the ground counter electrode. The applied field caused the polymer solution to exit the needle as fine liquid droplets, which were collected in liquid nitrogen and then dried in vacuum. The resulting porous particles containing aluminum flakes are shown in FIG. 3.

### Example 2

### Coaxial Nozzle Spray Freeze Drying Method for Preparation of Porous Particles

A solution of PICCOTONER 1221 is prepared in dimethyl carbonate (DMC) at 15% (w/v) with dispersed aluminum flakes (8.0% w/w based on total solids in solution). The solution is pumped through the inner capillary tubing of a coaxial setup as schematically shown in FIG. 2 as described above, with D1=150 μm, D2=363 μm, and D3=762 μm. A syringe pump is used to control the flow rate of the suspension at 10 mL/h. The air flow rate in the outer annular region is controlled by a pressure regulator on a compressed air cylinder and set at 50 psig. The polymer solution mixture is sprayed into a container half-filled with liquid nitrogen. The solvent is then removed under vacuum and porous particles containing encapsulated aluminum flakes are collected after freeze drying.

### Example 3

### Coaxial Nozzle Spray Freeze Drying Method for Preparation of Porous Particles Containing Aluminum Flakes

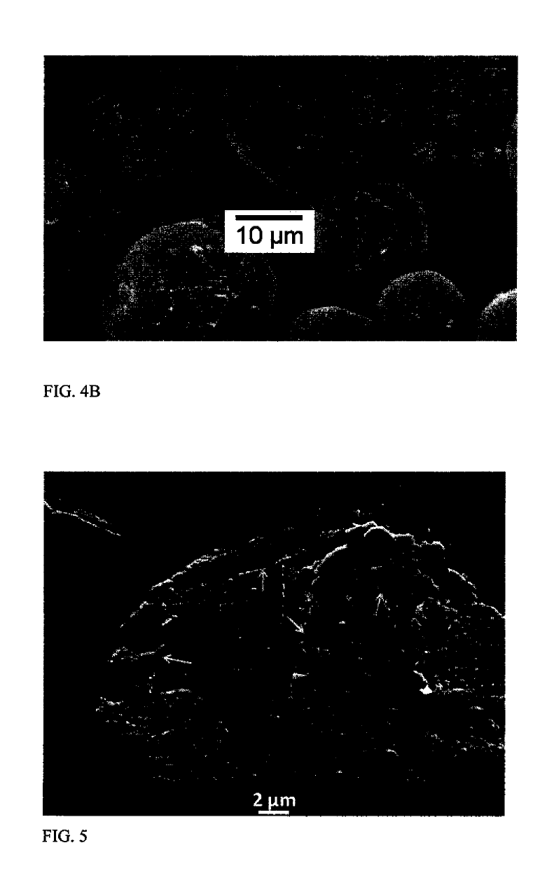

A suspension is made with PICCOTONER 1221 in dimethyl carbonate (15% w/v) and Aluminum flakes (0.75% w/v in suspension, or 5% w/w of PICCOTONER 1221) and filtered through a 60 μm membrane. The suspension is sprayed through a coaxial nozzle similarly as illustrated in FIG. 2 made with a capillary tubing with inner diameter D1 148 μm and length 6.6 cm, fitted with an outer plastic tubing (TPK 115) with a length of 4.0 cm. The suspension flow rate was controlled at 10 mL/h, and the air pressure in the outer sleeve was set at 50 psig. The polymer solution mixture was sprayed into a container half-filled with liquid nitrogen. The solvent was then removed under vacuum and particles were collected after freeze drying having a Dₙ and D_{w} of 14.7 and 18.3 μm, respectively (PDI=1.24). A repeat experiment resulted in particles with Dₙ and D_{w}, of 18.6 and 27.5 μm, respectively (PDI=1.48). A Scanning Electron Microscopy image of the resulting particles is shown in FIG. 4A. FIG. 4B is an SEM image of a sample of the resulting particles containing freeze-fractured particles. FIG. 5 is an SEM image of a cross-section of an individual particle, cut by microtome, made by spray/freeze drying in accordance with this embodiment of the invention comprising PICCOTONER 1221 as binder and containing A1 flakes. The arrows indicate the position of some flakes in the porous particle.

### Example 4

### Coaxial Nozzle Spray Freeze Drying Method for Preparation of Porous Particles Containing WE-3 Wax and Aluminum Flakes—PICCOTONER 1221 in Dimethyl Carbonate

Preparation of wax dispersion: to a glass jar containing a mixture of WE-3 wax (Nippon Oil and Fats, 25.0 g), TUFTEC P2000 dispersant (AK Elastomer, 5.0 g), and ethyl acetate (70.0 g) were added zirconia beads (diameter about 1.2 mm, 100 mL). The container was then placed on a (Sweco) powder grinder and the wax milled for three to five days. Afterwards, the beads were removed by filtration through a screen and the resulting solid particle dispersion recovered and particles have an average diameter of 0.55 microns.

A PICCOTONER 1221 (15% w/v) solution containing aluminum metal flakes (8.0% w/w based on total solids in solution) and WE-3 (8.0% w/w wax plus dispersant based on total solids in solution) with dimethyl carbonate (DMC) as the solvent was prepared. A syringe pump was used to control the flow rate of the polymer solution at 25 ml/hr through the inner capillary tubing of a coaxial spray apparatus (FIG. 2, with D1=150 μm, D2=363 μm, and D3=762 μm). The air flow rate in the outer annular region was controlled at 40 psig by a pressure regulator on a compressed air cylinder. The polymer solution mixture was sprayed into a container half-filled with liquid nitrogen. The solvent was then removed under vacuum and particles were collected as free-flowing powder. Dₙ and D_{w} are 21.4 and 30.5 μm, respectively (PDI=1.43).

### Example 5

### Coaxial Nozzle Spray Freeze Drying Method for Preparation of Porous Particles—FINETONE 382ES Polyester in Dimethyl Carbonate

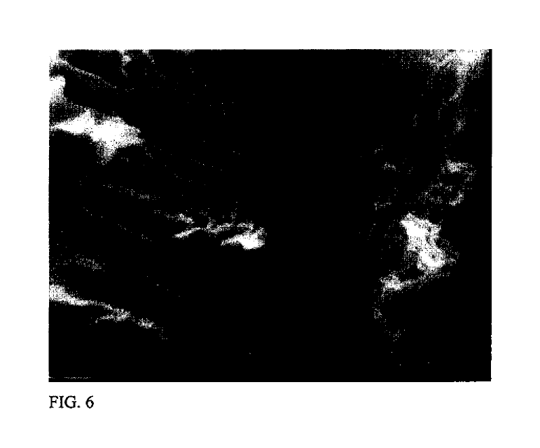

The experiment of Example 4 is repeated except that the polymer PICCOTONER 1221 is substituted with FINETONE 382ES polyester, and the capillary tubing used had an inner diameter D1 of 250 μm and the liquid flow rate was 30 mL/hr, at air pressure in the outer sleeve of 40 psig. After freeze drying the particles had a mean, median, and mode of diameter of 35.6, 32.0, and 41.8 μm, respectively, as measured on a Horiba LA-920 system. FIG. 6 is an SEM image of the inner structure of a porous polyester particle containing A1 flakes and wax prepared in accordance with such example which has been freeze-fractured.

### Example 6

### Coaxial Nozzle Spray Freeze Drying with 250 μm Nozzle

The experiment of Example 4 is repeated except that the capillary tubing used had an inner diameter D1 of 250 μm and the liquid flow rate was 25 mL/hr, at air pressure in the outer sleeve of 40 psig. The obtained particles after freeze drying had mean particle diameter of 42.6 μm, median diameter of 39.7 μm, and mode of 48.0 μm as measured on a Horiba LA-920 instrument.

### Example 7

### Comparative Example

### An Emulsification Method for Particle Preparation

An oil phase, 20% w/v PICCOTONER 1221 in chloroform and 5% w/v metal flakes, was emulsified into water (5 times of the volume of solvent) containing PVA surfactant (1% w/v in water) by an IKA Works Ultra-turrax homogenizer (21500 rpm, 1 min). The resulting emulsion was stirred magnetically overnight in open air to evaporate the solvent. The aluminum flakes were found to separate from the binder and no encapsulation was observed.

The invention has been described in detail with particular reference to certain preferred embodiments thereof, but it will be understood that variations and modifications can be effected within the spirit and scope of the invention.

1. A process for forming polymer particles containing metallic flakes, comprising:
a) forming a suspension of metallic flakes in a solution of a polymeric binder in a solvent;
b) forming droplets of the suspension;
c) freezing the droplets to freeze solvent in the droplets to form frozen solvent domains within the polymeric binder; and
d) removing the frozen solvent from the polymeric binder thereby forming porous polymer particles containing the metallic flakes encapsulated therein.

2. The process according to claim 1, wherein the droplets of the suspension are formed by spraying the suspension.

3. The process according to claim 1, wherein the frozen solvent is removed from the frozen droplets under conditions of reduced pressure.

4. The process according to claim 1, wherein the suspension also contains a wax dispersion.

5. The process according to claim 1, wherein the polymeric binder comprises a copolymer resin derived from styrene and acrylic monomers, or a polyester resin.

6. The process according to claim 1, wherein the polymeric binder has a concentration of about 10% to about 50% by weight in the suspension.

7. The process according to claim 1, wherein the solvent is dimethyl carbonate.

8. The process according to claim 1, wherein the metallic flakes are substantially 2-dimensional particles, having opposed main surfaces separated by a relatively minor thickness dimension, and have a main surface equivalent circular diameter primarily in the range of from about 2 microns to about 20 microns, and an aspect ratio of at least 2.

9. The process according to claim 8, wherein where the metallic flakes have an aspect ratio of at least about 5.

10. The process according to claim 1, wherein the metallic flakes are present at a concentration of from about 3% to about 30% by weight relative to that of the polymeric binder.

11. The process according to claim 1, wherein the metallic flakes comprise copper or aluminum.

12. The process according to claim 1, wherein the droplets are formed by spraying the suspension through a coaxial capillary nozzle.

13. The process according to claim 12, wherein the capillary nozzle has an inner conduit opening diameter of about 100 microns to about 350 microns through which the suspension is sprayed, and an outer sleeve through which gas is flowed having an annular opening outer diameter of from about 500 microns to about 1500 microns.

14. The process according to claim 13, wherein the droplets are formed at a flow-rate of about 10-50 mL/hour, and a gas pressure in the outer sleeve of about 20 psi to about 50 psi.

15. The process according to claim 1, wherein the droplets are formed by electrospraying.

16. The process according to claim 1, wherein the droplets are frozen in liquid nitrogen.
